(19) United States
(12) Patent Application Publication
(10) Pub. No.: US 2016/0088704 A1
(43) Pub. Date: Mar. 24, 2016

(54) LOW FLICKER ALTERNATING CURRENT (AC) LED DRIVER

(71) Applicant: LuxTech, LLC, Philadelphia, PA (US)

(72) Inventors: Ronald J. Lenk, Marietta, GA (US); Jianchuan Tan, Menands, NY (US)

(21) Appl. No.: 14/861,981

(22) Filed: Sep. 22, 2015

Related U.S. Application Data
(60) Provisional application No. 62/053,413, filed on Sep. 22, 2014.

(51) Int. Cl. H05B 33/08

(52) U.S. Cl. CPC H05B 33/0851; H05B 33/0809

(57) ABSTRACT

In some embodiments, an apparatus comprising a rectifier that is configured to rectify an Alternating Current (AC) from an AC line to produce a rectified line voltage, at least one resistor operatively coupled to the rectifier, and at least one capacitor operatively coupled to the at least one resistor and ground is disclosed. In some instances, the at least one resistor and the at least one capacitor form a low-pass filter configured to reduce a ripple voltage of the rectified line voltage of the rectifier. In some instances, the at least one resistor and the at least one capacitor are configured to provide a minimum voltage on the at least one capacitor that is high enough to maintain at least one LED conducting current at a minimum level and maintain the at least one LED operational for substantially all of a line cycle of the AC line when the at least one LED is operatively coupled to the at least one capacitor.

### CROSS REFERENCES TO RELATED APPLICATIONS

This application is a non-provisional of and claims priority under 35 U.S.C. §119 to U.S. provisional application Ser. No. 62/053,413, filed Sep. 22, 2014, titled “LOW FLICKER AC LED DRIVER.”

This application is related to and a continuation of PCT international application no. PCT/US2014/025313, filed Mar. 13, 2014, titled “Universal Input LED Driver,” and related to and a continuation of PCT international application no. PCT/US2014/068584, filed Dec. 4, 2014, titled “Multiple Input LED Driver.”

The aforementioned applications are all herein expressly incorporated by reference in their entireties.

### FIELD OF THE INVENTION

The present application relates to providing a low flicker alternating current (AC)-line input light emitting diode (LED) driver, and more particularly, to providing a driver that runs from an AC line source and produces low optical flicker, without using a Switch-Mode Power Supply (SMPS), and while maintaining a high Power Factor (PF).

### BACKGROUND OF THE INVENTION

It is frequently desirable to power LEDs from the AC line. LEDs typically have a forward voltage while conducting current of approximately 3V. This voltage varies somewhat as a function of the drive current and temperature, typically ±20%. However, LEDs, being diodes, need to be driven with a current rather than a voltage. For this reason, LEDs are frequently driven by switch-mode power supplies (SMPS), which convert the high-voltage AC line voltage to a low-voltage current.

However, SMPS tend to be expensive and may have a relatively short lifetime compared with that of the LEDs they are driving. For this reason, some designs use a string of LEDs attached to the line, with a sufficient number of LEDs in series in the string to present a forward voltage of approximately the line voltage. Some designs place the LED string directly across the AC line; however, since LEDs are unidirectional, the LEDs in this arrangement conduct only during half of each line cycle. Other designs first rectify the AC line and then apply the rectified voltage to the string of LEDs; in this arrangement, the LEDs conduct during both halves of the line cycle, thus providing double the light output of the first configuration.

However, such designs suffer from a number of problems. One of these problems is the low utilization of the LEDs, which is to say, the amount of light produced per LED is relatively low. Since the string of LEDs has a forward voltage roughly comparable with the line voltage, the LEDs do not turn on at all until a substantial fraction of the peak line voltage is reached by the AC line. They are thus off for a significant fraction of the line cycle, resulting in less light output per LED than if they were on longer. Furthermore, since the LEDs are off for a significant fraction of the line cycle, line frequency flicker may be more noticeable with this system than if they were on longer.

One solution to the flicker problem is to attach a large capacitance to the output of the rectifier, thus ensuring power to the LEDs throughout the line cycle. However, in some instances, this solution may be unsatisfactory as it may result in a low PF, contrary to the goal of achieving high PF in LED lighting.

A further problem with these designs is that, without the capacitor, as the line voltage rises, the peak current through the LEDs may be substantially higher than the average, which may adversely affect both the LED efficiency and lifetime.

It would be desirable to have an AC drive circuit that conducts current through the LEDs for a large fraction of the line cycle, to improve LED utilization and reduce flicker. It would be desirable for this circuit to have a high power factor. It would also be desirable that such a circuit should control the maximum current through the LEDs without adversely affecting efficiency, and thus could provide for long life of the LEDs. It would also be desirable that the circuit be inexpensive and itself have a long lifetime.

### SUMMARY OF THE INVENTION

Embodiments of the current disclosure include an apparatus comprising a rectifier that is configured to rectify an Alternating Current (AC) from an AC line to produce a rectified line voltage, at least one resistor operatively coupled to the rectifier, and at least one capacitor operatively coupled to the at least one resistor and ground. For example, the rectifier can be a diode bridge rectifier. In some instances, the at least one resistor and the at least one capacitor form a low-pass filter configured to reduce a ripple voltage of the rectified line voltage of the rectifier. In some instances, the at least one resistor and the at least one capacitor are configured to provide a minimum voltage on the at least one capacitor that is high enough to maintain at least one LED conducting current at a minimum level and maintain the at least one LED operational for substantially all of a line cycle of the AC line when the at least one LED is operatively coupled to the at least one capacitor.

Further, the apparatus may comprise a second resistor operatively coupled to the capacitor, the capacitor being connected to the ground via the second resistor. In some embodiments, a diode may be operatively coupled to the capacitor, and the capacitor can be connected to the ground via the diode in parallel with the second resistor.

In some embodiments, when the at least one LED is operatively coupled to the at least one capacitor, a current level through the at least one LED can be at most equal to a current level through a current sink coupled to the at least one LED, the current level through the LED can be substantially constant during a continuous operation of the LED, and/or the minimum voltage on the at least one capacitor may be high enough to maintain the at least one LED conducting current at a level equal to a current sink coupled to the LED. In at least the latter case, a voltage across the current sink substantially corresponding to the maximum voltage on the capacitor can be configured to be less than a threshold voltage at which power is dissipated in the current sink.

In some embodiments, the at least one LED may be included within a series string of LEDs. Further, the at least one LED may be connected to ground via a current sink (e.g., a current diode), and in such embodiments, the current sink is configured to draw current in an amount to produce a predefined light output from the at least one LED while not exceeding a maximum rated current for the LED. In some embodiments, the at least one LED is connected to ground via a current sink that includes a controlled element, the controlled element configured to be controlled by negative feedback related to current flowing through the controlled element. In such embodiments, the controlled element can be a transistor, and/or during operation of the controlled element, the negative feedback can be provided by a current sense resistor and a difference amplifier responsive to the negative feedback to provide a control signal to reduce current through the controlled element when the negative feedback indicates a current reference value is exceeded.

### BRIEF DESCRIPTION OF THE DRAWINGS

The accompanying drawing is included to provide a further understanding of the present disclosure, and is incorporated in and constitute a part of this specification. The drawings primarily are for illustrative purposes and are not intended to limit the scope of the inventive subject matter described herein.

FIG. 1A shows an schematic block diagram of a low-flicker AC LED drive circuit, according to an embodiment of the present disclosure.

FIG. 1 is a diagram of a low-flicker AC LED drive circuit, in which a string of LEDs is run from a drive circuit powered from the AC line in an embodiment of the present disclosure.

FIG. 2 is a drawing of a voltage waveform appearing on a capacitor of the low-flicker AC LED drive circuit of FIG. 1, according to an embodiment of the present disclosure.

FIG. 3 is a drawing of a current waveform through the string of LEDs driven by the low-flicker AC LED drive circuit of FIG. 1, according to an embodiment of the present disclosure.

FIG. 4 is a drawing of a current waveform drawn from the AC line by the low-flicker AC LED drive circuit of FIG. 1, according to an embodiment of the present disclosure.

### DETAILED DESCRIPTION

Embodiments of the present disclosure herein relate to an AC LED drive circuit configured for driving one or more LEDs by conducting current through the LEDs for a large fraction of the line cycle of the AC line powering the LEDs. In some instances, the efficiency of the LED driver is such that the power factor (PF) of the LEDs, i.e., the proportion or ratio of power directed to light output by the LEDs compared to the power provided by the AC source, is substantial. Further, the LED driver is configured to regulate the amount of current that flows through the LEDs so as to protect the LEDs from fluctuations in current (e.g., pronounced peaks in the current profile), thereby enhancing the performance, efficiency and lifetime of the LEDs. Further, the AC LED produces low optical flicker without using a Switch-Mode Power Supply (SMPS).

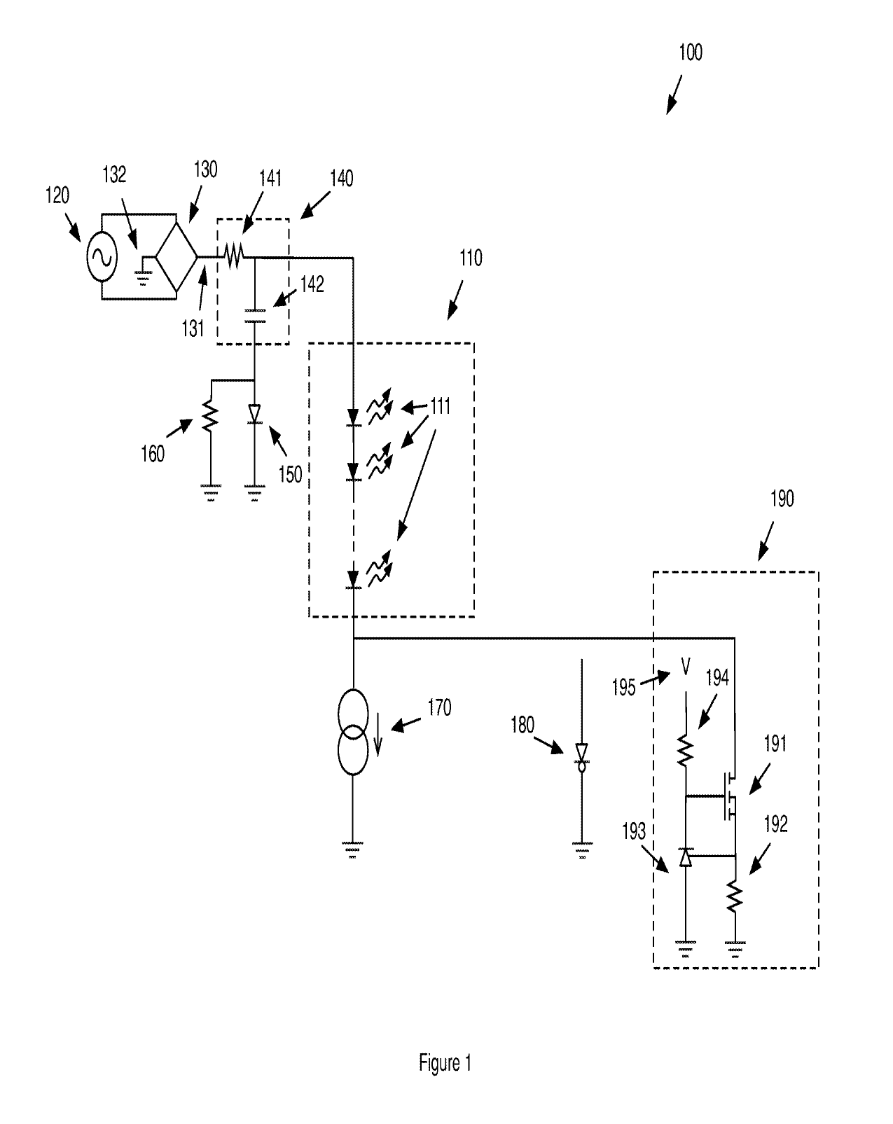

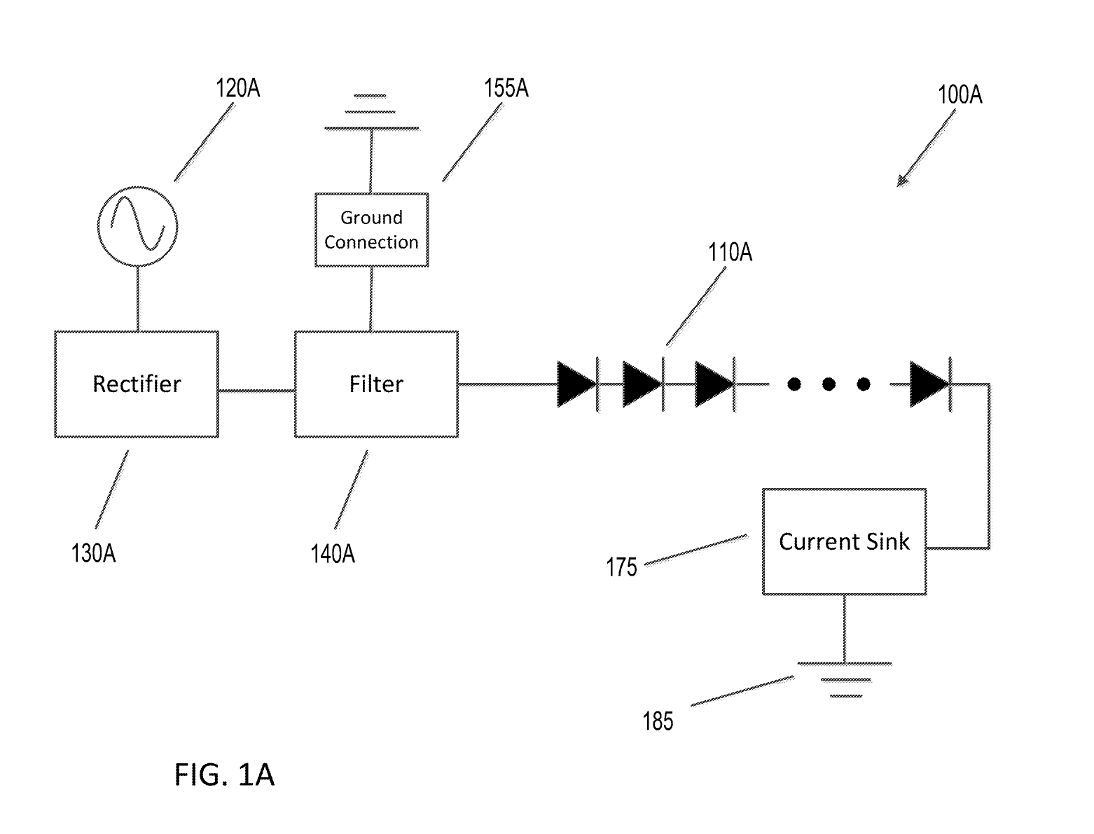

With reference to the embodiment shown in FIG. 1A, a low-flicker AC LED circuit drive 100A is shown. The LED circuit drive 100A comprises a rectifier 130A configured to rectify an AC output provided by an AC line or source 120A. For example, the rectifier 130A may be configured to convert AC current provided by the AC source 120A into a DC voltage that can be used to power the LEDs 110A. As used herein, a DC voltage (respectively current) is a voltage (respectively current) with a single polarity, but may still have a substantial AC component. The rectifier 130A can be, for example, a half-wave rectifier, a full wave rectifier, a single phase rectifier, a poly-phase rectifier (e.g., three phase, six phase, etc.), and/or the like. In some instances, these rectifiers may be built around a four-diode bridge configuration, so-called diode bridge rectifiers. The rectification may be accomplished, for example, with diodes, transistors or other types of rectifiers.

The output of the rectifier 130A may be fed into a filter 140A for further processing. For example, a filter 140A may receive a rectified AC output from the rectifier 130A and filter certain components of the received output. For example, the filter 140A may remove some or all of the “ripple” waveforms that may be produced when the AC output is rectified or converted into a DC output by the rectifier 130A. In some instances, these ripple waveforms (e.g., ripple voltage) accompanying the DC output may have a high frequency; for example, the frequency of the ripple voltage may be twice as high as the frequency of the voltage of the AC line. In such embodiments, the filter 140A may be a low-pass filter that removes and/or blocks the passage of components of the rectified AC output with these higher frequencies, i.e., it may filter out the “ripple” components and leave a substantially DC output. In some instances, the filter 140A may be a low pass filter, a high pass filter, a bandpass filter, a notch/band-reject filter, or an all-pass/phase-shift filter configured to at least substantially remove and/or block those components of the output having certain frequencies. For example, a filter 140A comprising a capacitor and a resistor may form a low-pass filter configured to block those components of the output (including ripples, for example) that have frequencies above a certain threshold frequency. In some instances, this threshold frequency may correspond to the frequency at which light output coming out of the LEDs 110A appears to be steady and not flickering. In some embodiments, the capacitor and the resistor may be selected so that components of the output with frequencies much greater than the inverse of the product of the capacitance C of the capacitor and resistance R of the resistance, i.e., 1/RC, may be blocked. For example, for an AC line frequency of about 60 Hz, the time constant of such a filter may be about at least a few or several milliseconds, and as such, components of the rectified output with frequency higher than the inverse of this time constant may be blocked. In some instances, the filter 140A may be a low pass filter including an inductor, such as a pi filter.

In some embodiments, the filter 140A may be grounded via a grounding connection 155A. For example, the filter 140A comprising a low-pass filter that includes a capacitor and a resistor may be grounded via a resistor, and/or via a parallel combination of a diode and a resistor.

In some embodiments, the filtered, rectified AC output may be fed into the LEDs 110A so as to power the LEDs 110A and produce a light output. In some instances, the AC output may be configured to allow the conduction of at least approximately constant current through the LEDs 110A. For example, the components of the low-pass filter (e.g., a capacitor and a resistor for capacitive low-pass filters, inductors for inductive low-pass filters, etc.) may be selected (or configured or arranged) such that an approximately constant current of a desired value flows through the LEDs 110A. In some instances, the current may be variable. In some instances, the AC output may be configured to allow the conduction of either an at least approximately constant and/or variable current through the LEDs 110A for at least some fraction of the period of a line cycle of the AC line or source 120A. In some instances, this time duration may be greater than about 70%, 80%, 90%, etc., of the line cycle, and in some instances, it may be at least approximately equal to about 100% of the line cycle. In some embodiments, the amount of current flowing through the LEDs and/or the time duration may be such that the PF of the AC LED circuit drive 100A can be about 0.8, about 0.85, about 0.9, about 0.95, about 1, and/or the like.

In some embodiments, the components of the low-pass filter (e.g., a capacitor and a resistor for capacitive low-pass filters, inductors for inductive low-pass filters, etc.) may be selected (or configured or arranged) such that, during a line cycle, the voltage appearing on at least some of the components (e.g., the capacitor for a capacitive low-pass filter) may be high enough to keep the LEDs 110A conducting current at some minimum level but low enough to not cause excessive dissipation and damage to the LEDs 110A, or at least to not negatively affect the performance of the LEDs 110A. For example, the current flowing through the LEDs 110A may not exceed the maximum rated current of the LEDs 110A. As such, in some instances, the voltage on the capacitor may oscillate between some minimum and maximum values. Correspondingly, the voltage across the LEDs 110A, and consequently the current through the LEDs 110A, may oscillate between some minimum and maximum values as well. In some instances, the minimum and the maximum voltages on the components of the low pass filter and/or across the LEDs 110A may correspond to PF values for the AC LED circuit drive 100A ranging from about 0.8 to about 1, respectively.

In some embodiments, the current flowing through the LEDs 110A may be drawn by a current sink 175. The current sink 175 may be configured to draw current so that the current flowing through the LEDs 110A may be high enough to attain a desired level of light output from the LEDs 110A but low enough to not cause excessive dissipation and damage to the LEDs 110A, or at least to not negatively affect the performance of the LEDs 110A. For instance, the current drawn by the current sink and flowing through the LEDs 110A may not exceed the maximum rated current of the LEDs 110A. The voltage appearing across the current sink 175 may range from a minimum of zero to a maximum low enough not to dissipate excessive power in the current sink 175. Similarly, the current sink 175 may be configured to draw current such that the current flows through the LEDs 110A at least for some part of the period of the line cycle of the AC line 120. For example, the current may flow for about 85%, about 90%, about 95%, about 100%, etc., of the line cycle.

In some embodiments, the current sink 175 may be in the form of one or more current diodes.

In some embodiments, the current sink 175 may be in the form of a current feedback regulated circuit configured to sense the current in a component of the current sink 175, and provide feedback to another component of the current sink 175 to adjust the amount of current to be drawn through the LEDs 110A. For example, a current sensor in the current sink 175 may sense when the current flowing through a resistor in the current sink 175 exceeds a threshold above which damage may occur to the LEDs 110A and/or excessive power may be dissipated within the current sink 175. In such embodiments, the current sensor may provide feedback to a regulator in the current sink 175 so as to adjust the current to be drawn to avoid or reduce the aforesaid damage or excessive power dissipation. In some embodiments, other types of sensors may be used to sense the state of the components of the current sink. For example, a voltage sensor may be used, instead of or in addition to a current sensor, in the current sink 175 to measure voltage level in the current sink 175 so as to regulate the current to be drawn through the LEDs 110.

FIG. 1 is a diagram of an exemplary embodiment of a low-flicker AC LED drive circuit 100, in which a string 110 of LEDs 111 is run from the drive circuit 100 powered from the AC line 120. As shown in FIG. 1, the AC line 120 is rectified by a diode bridge 130, producing a positive voltage 131 and ground 132. The diode bridge 130 may also be referred to as a rectifier, rectifier bridge, or diode bridge rectifier. The output of the diode bridge 130 is fed into a low-pass filter 140, comprising a regulating resistor 141 and a capacitor 142. The capacitor 142 is attached to ground 132 through a parallel combination of a diode 150 and an oscillator resistor 160. The capacitor 142 is attached to the anode of the diode 150 as shown. The output of the low-pass filter 140 is fed into the anodes of one or more strings 110 of LEDs 111. The cathode output of the one or more strings 110 of LEDs 111 is fed into a current sink 170. In one embodiment, the current sink 170 may be one or more current diodes 180.

In a different embodiment, the current sink 170 may be a current feedback-regulated circuit 190, comprising a transistor 191 attached to a current sense resistor 192, with feedback provided by a shunt regulator 193. In operation, the shunt regulator 193 controls the gate voltage on the transistor 191 sourced by a gate resistor 194 to a power source 195. The current through the transistor 191 flows through the current sense resistor 192, producing a voltage on the control of the shunt regulator 193. If the current through the transistor 191 is too high, the voltage across the current sense resistor 192 and applied to the control of the shunt regulator 193 will also be high. This causes the shunt regulator 193 to pull additional current through the gate resistor 194, reducing the gate voltage on the transistor 191. The reduced gate voltage on the transistor 191 reduces the current through the transistor 191, thus providing negative feedback and controlling the current pulled by the current feedback-regulated circuit 190.

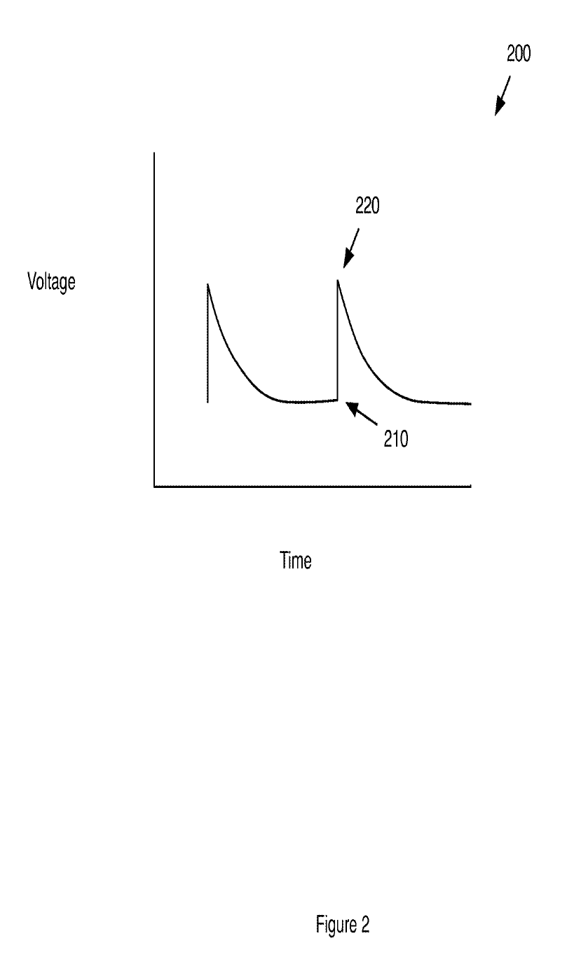

FIG. 2 is a drawing of the voltage waveform 200 appearing across the capacitor 142 of the low-flicker AC LED drive circuit 100. As shown in FIG. 2, the voltage waveform 200 oscillates between a certain minimum voltage 210 and another certain maximum voltage 220. In one embodiment, the certain minimum voltage 210 is such that the one or more strings 110 of LEDs 111 will continue emitting light when the voltage waveform 200 is at the certain minimum voltage 210. In a further embodiment, the certain maximum voltage 220 may be such that the residual voltage across the current sink 170 does not produce excessive power dissipation in the current sink 170.

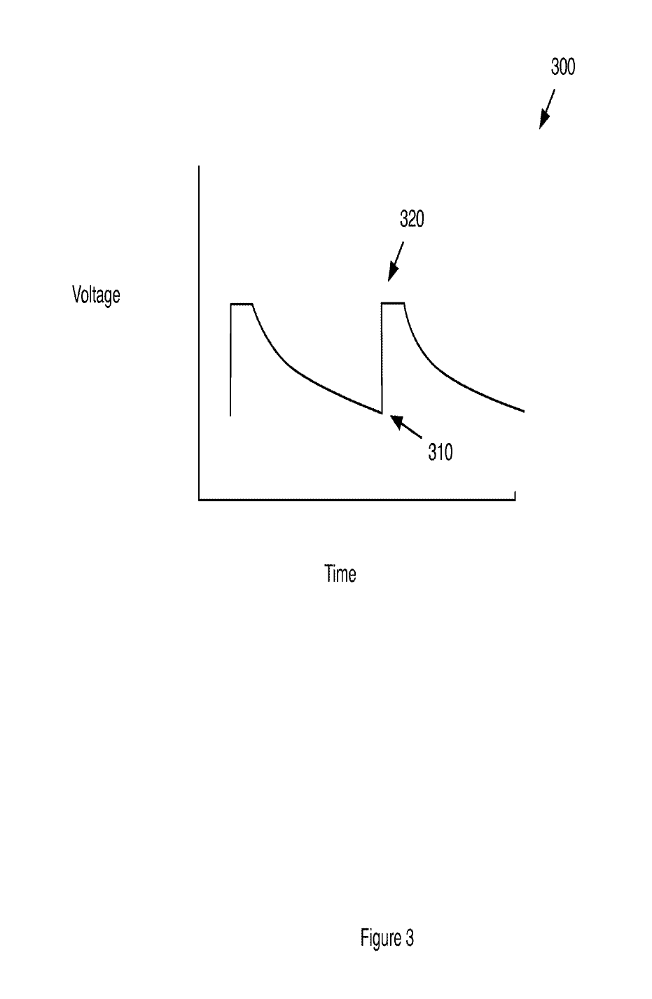

FIG. 3 is a drawing of the current waveform 300 through the one or more strings 110 of LEDs 111 driven by the low-flicker AC LED drive circuit 100. As shown in FIG. 3, the current through the one or more strings 110 of LEDs 111 reaches a minimum 310, which corresponds in time to when the certain minimum voltage 210 is reached across the capacitor 142. In an exemplary embodiment, this minimum current 310 is greater than zero, and is a substantial fraction of the current set by the current sink 170. The current through the one or more strings 110 of LEDs 111 reaches a maximum 320, which is set by the current pulled by the current sink 170. In the exemplary embodiment, the maximum current 320 through the one or more strings 110 of LEDs 111 persists for a significant fraction of the line cycle of the AC line 120.

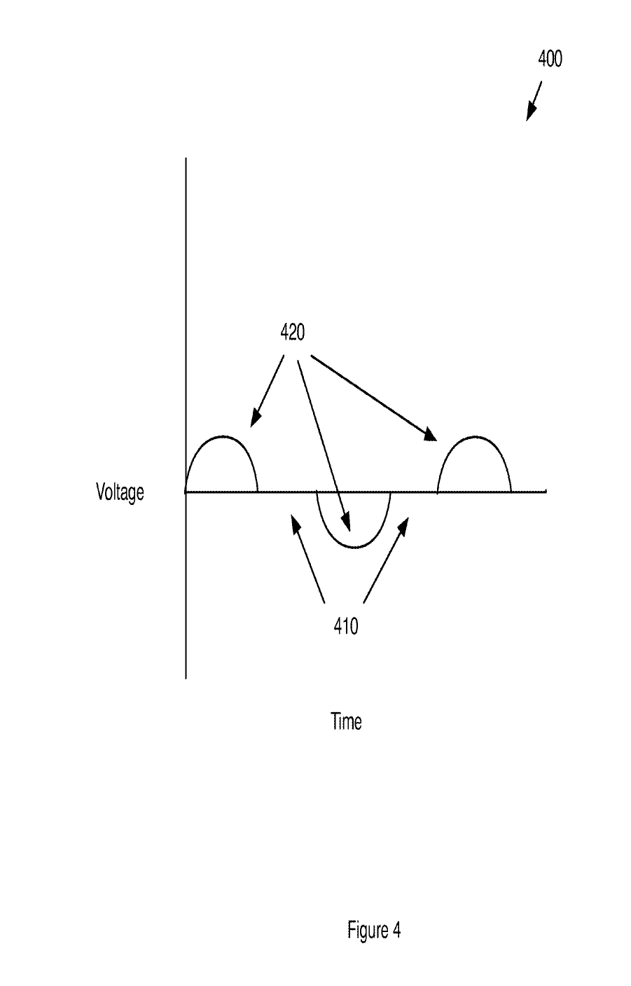

FIG. 4 is a drawing of the current waveform 400 drawn from the AC line 120 by the low-flicker AC LED drive circuit 100. As shown in FIG. 4, the current drawn from the AC line 120 is zero during certain periods 410 and sinusoidal during the rest of the time 420. This sinusoidal current draw is what ensures a high PF.

It will be apparent to those skilled in the art that various modifications and variation can be made to the structure of the disclosed embodiments. In view of the foregoing, it is intended that this disclosure covers modifications and variations.

While various embodiments have been described and illustrated herein, a variety of other means and/or structures for performing the function and/or obtaining the results and/or one or more of the advantages described herein. More generally, all parameters, dimensions, materials, and configurations described herein are meant to be an example and that the actual parameters, dimensions, materials, and/or configurations will depend upon the specific application or applications. It is, therefore, to be understood that the foregoing embodiments are presented by way of example only and that embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure. Still further, some embodiments disclosed herein are distinguishable over prior art references by specifically lacking one or more features disclosed in the prior art; that is, claims to such embodiments may include negative limitations so as to be distinguished from the prior art.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Any and all references to publications or other documents, including but not limited to, patents, patent applications, articles, webpages, books, etc., presented anywhere in the present application, are herein incorporated by reference in their entirety. Moreover, all definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An apparatus, comprising:
a rectifier configured to rectify an Alternating Current (AC) from an AC line to produce a rectified line voltage;
at least one resistor operatively coupled to the rectifier; and
at least one capacitor operatively coupled to the at least one resistor and ground, the at least one resistor and the at least one capacitor forming a low-pass filter configured to reduce a ripple voltage of the rectified line voltage of the rectifier;
the at least one resistor and the at least one capacitor being configured to provide a minimum voltage on the at least one capacitor that is high enough to maintain at least one LED conducting current at a minimum level and maintain the at least one LED operational for substantially all of a line cycle of the AC line when the at least one LED is operatively coupled to the at least one capacitor.

2. The apparatus of claim 1, wherein the rectifier is a diode bridge rectifier.

3. The apparatus of claim 1, further comprising:
a second resistor operatively coupled to the capacitor,
the capacitor being connected to the ground via the second resistor.

4. The apparatus of claim 1, further comprising:
a second resistor operatively coupled to the capacitor;
a diode operatively coupled to the capacitor;
the capacitor being connected to the ground via the diode in parallel with the second resistor.

5. The apparatus of claim 1, wherein a current level through the at least one LED is at most equal to a current level through a current sink coupled to the at least one LED, when the at least one LED is operatively coupled to the at least one capacitor.

6. The apparatus of claim 1, wherein a current level through the LED is substantially constant during a continuous operation of the LED, when the at least one LED is operatively coupled to the at least one capacitor.

7. The apparatus of claim 1, wherein the minimum voltage on the at least one capacitor is high enough to maintain the at least one LED conducting current at a level equal to a current sink coupled to the LED, when the at least one LED is operatively coupled to the at least one capacitor.

8. The apparatus of claim 1, wherein:
the minimum voltage on the at least one capacitor is high enough to maintain the at least one LED conducting current at a level equal to or less than a current level at a current sink coupled to the LED, when the at least one LED is operatively coupled to the at least one capacitor, and
a voltage across the current sink substantially corresponding to the maximum voltage on the capacitor is configured to be less than a threshold voltage at which power is dissipated in the current sink, when the at least one LED is operatively coupled to the at least one capacitor.

9. The apparatus of claim 1, wherein the at least one LED is included within a series string of LEDs.

10. The apparatus of claim 1, wherein the at least one LED is connected to ground via a current sink.

11. The apparatus of claim 1, wherein:
the at least one LED is connected to ground via a current sink, and
the current sink is configured to draw current in an amount to produce a predefined light output from the at least one LED while not exceeding a maximum rated current for the LED.

12. The apparatus of claim 1, wherein the at least one LED is connected to ground via a current sink that is a current diode.

13. The apparatus of claim 1, wherein the at least one LED is connected to ground via a current sink that includes a controlled element, the controlled element configured to be controlled by negative feedback related to current flowing through the controlled element.

14. The apparatus of claim 1, wherein:
the at least one LED is connected to ground via a current sink that includes a controlled element, the controlled element configured to be controlled by negative feedback related to current flowing through the controlled element, and
the controlled element is a transistor.

15. The apparatus of claim 1, wherein:
the LED is connected to ground via a current sink that includes a controlled element, the controlled element configured to be controlled by negative feedback related to current flowing through the at least one controlled element, and
during operation of the controlled element, the negative feedback is provided by a current sense resistor and a difference amplifier responsive to the negative feedback to provide a control signal to reduce current through the controlled element when the negative feedback indicates a current reference value is exceeded.
